(19) United States
(12) Patent Application Publication
(10) Pub. No.: US 2005/0015536 A1
(43) Pub. Date: Jan. 20, 2005

(54) PERIPHERAL DEVICE HAVING A PERSONAL DISK USED FOR STORING DEVICE DRIVERS

(76) Inventor: Kuei-Jung Lee, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,455

(22) Filed: Sep. 30, 2003

(30) Foreign Application Priority Data
Jul. 14, 2003 (TW) 092119171

(51) Int. Cl. G06F 13/20

(52) U.S. Cl. 710/313

(57) ABSTRACT

A peripheral device having a personal disk used for storing device drivers. The peripheral device can be connected to an interface port of an electronic device host. The peripheral device has a housing, an application module for performing a predetermined operation, a storage module for storing a device driver of the application module, and a hub controller electrically connected to the application module and the storage module. When the hub controller is electrically connected to the interface port, the computer host can retrieve the device driver of the application module through the hub controller, and can run the device driver to control the application module to perform the predetermined operation.

### BACKGROUND OF INVENTION

1. Field of the Invention

The present invention relates to a peripheral device. In particular, the present invention discloses a peripheral device having a personal disk used for storing device drivers.

2. Description of the Prior Art

In order to support plug & play functionality and high data transmission speed required by customers, new peripheral interfaces such as a universal serial bus (USB) interface and an IEEE1394 interface gradually take place of the old-fashioned parallel port and the serial port. The USB interface was established by many companies such as Intel®, Compaq®,Digital®, Microsoft®, and NEC® in 1993. It is wellknown that one USB port is capable of connecting up to 127 peripheral devices, and all of the peripheral devices share the same bus bandwidth. Furthermore, the peripheral device compatible with the USB specification can be directly connected to a currently booted computer host. That is, the USB-compatible peripheral device supports hot swap functionality. With regard to the IEEE1394 interface, one IEEE1394 bus is capable of supporting up to 63 peripheral devices. Similarly, the IEEE1394-compatible peripheral device supports the above-mentioned hot swap functionality as well. Therefore, the users can conveniently install peripheral devices onto the computer host through the USB port or the IEEE1394 port positioned on the computer host.

Please refer to FIG. 1, which is a block diagram of a prior art computer system 10. The computer system 10 has a computer host 12, and the computer host 12 includes a central processing unit (CPU) 14, a north bridge circuit 16, a south bridge circuit 18, a display driving circuit 20, a memory 22, an optical disk drive 24, a hard disk drive 26, and a monitor 28. The CPU 14 is used to control overall operation of the computer system 10. The north bridge circuit 16 is used to control data transmission between the CPU 14 and the high-speed devices such as the display driving circuit 20 and the memory 22. The south bridge circuit 18 is used to control data transmission between the south bridge circuit 16 and low-speed devices such as the optical disk drive 24 and the hard disk drive 26. The display driving circuit 20 is used to do 2D graphic processing and 3D graphic processing, and then generates video signals for driving the monitor 28 to show corresponding image frames. As mentioned above, the user can install peripheral devices onto the computer host 12 through a USB port or an IEEE1394 port. Taking the USB port for example, the south bridge circuit 18 has a USB host controller 30 for controlling data transmitted via a USB bus. Suppose that the USB host controller 30 itself only supports two ports 32a, 32b, and the user desires to use more that three peripheral devices on the computer system 10. Therefore, a USB hub 33 is necessary to provide more ports 34a, 34b, 34c. Please note that ports 32a, 32b are downstream ports for the USB host controller 30 to connect external peripheral devices. Similarly, for the USB hub 33, ports 34b, 34c are also downstream ports used for connecting external peripheral devices. However, the port 34a is an upstream port for connecting the port 32a or the port 32b. As shown in FIG. 1, the port 34a is electrically connected to the port 32b. Therefore, the peripheral devices connected to the ports 34b, 34c can deliver data to the USB host controller 30 or receive data from the USB host controller 30 through the connection between the port 34a and the port 32b. Because the USB hub 33 provides a plurality of ports 34b, 34c, the goal of increasing a total amount of connectible peripheral devices is achieved. From FIG. 1, a keyboard 36 is connected to the port 32a for the user to input keyboard signals to the computer host 12. In addition, with the help of the USB hub 33, a personal disk 38 is capable of being connected to the port 34c, and a WLAN module 40 can be connected to the port 34b. That is, three peripheral devices have been successfully installed on the computer host 12.

After the computer system 10 is powered on, the computer system 10 starts a power-on-self-test (POST) process. Then, an operating system (OS) is loaded. When the CPU 14 runs the OS, the OS loads device drivers according to the hardware components installed within the computer system 10 for controlling operations of the hardware components. For instance, a display driver is used to control the display driving circuit 20 to processing image data and generate video signals for driving the monitor 28. In other words, when a new hardware component is installed on the computer system 10, the user needs to do a corresponding device driver installation so that the OS is capable of driving the added hardware component correctly. For example, the WLAN module 40 is connected to the port 34b through a hot swap operation. Suppose that the WLAN module 40 has never been installed on the computer system 10 before. That is, the WLAN module 40 is a newly added hardware component for the computer system 10. If the OS is unable to find out a device driver suitable for this unknown WLAN module 40, the OS shows a dialog window on the monitor 28 to ask the user about a target location of the wanted device driver of the WLAN module 40. Then, the user inserts an optical disk having the required device driver into the optical disk drive 24. In the end, the OS loads the device driver of the WLAN module 40, and the device driver is stored on the hard disk drive 26. In addition, information associated with the WLAN module 40 and the corresponding device driver is recorded by a registry file of the OS. Therefore, when an identical WLAN module 40 is installed on the computer system 10 again, the WLAN module 40 is no longer an unfamiliar hardware component for the computer system 10 because the device driver installation has been done previously, and the registry file of the OS has kept the registry codes related to the WLAN module 40. Therefore, the OS can directly load the wanted device driver stored on the hard disk drive 26 through the information provided by the registry file, and the WLAN module 40 is controlled correctly.

As mentioned above, when the user installs a new hardware component such as the WLAN module 40 onto the computer system 10 through one of the ports 32a, 32b, 32c, the user needs to do a device driver installation if the OS of the computer system 10 does not support this new hardware component yet. That is, the manufacturer of the WLAN module 40 has to provide the user with an optical disk or a magnetic disk that contains the required device driver. However, if the user loses the optical disk or the magnetic disk that records the device driver, the WLAN module 40 can function normally on the computer system 10 after the user recovers the lost optical disk or the lost magnetic disk. Furthermore, if the user wants to use the same WLAN module 40 on different computer devices, the user has to carry the optical disk or the magnetic disk that records the device driver so as to do the device driver installation for the computer devices. To sum up, because a device driver of a peripheral device is stored on one optical disk or one magnetic disk without being combined with the peripheral device, the user needs both of the peripheral device and the device driver to successfully apply the peripheral device on one computer device. However, it is not convenient for the user to carry and keep the device driver. Therefore, the utilization of the prior art peripheral device is not convenient for the user.

### SUMMARY OF INVENTION

It is therefore a primary objective of this invention to provide a peripheral device having a personal disk used for storing device drivers.

Briefly summarized, the preferred embodiment of the present invention discloses a peripheral device capable of being connected to an interface port on an electronic device host. The peripheral device has a housing, an application module positioned at least partially inside the housing, a storage module positioned inside the housing for storing a device driver of the application module, and a hub controller positioned inside the housing and electrically connected to the application module and the storage module. When the hub controller is electrically connected to the interface port, the electronic device host is capable of retrieving the device driver stored by the storage module and running the device driver to operate the application module.

It is an advantage of the present invention that the claimed peripheral device combines a personal disk and an application module. When the user carries the claimed peripheral device, a device driver of the application module travels along with the application module. Therefore, the inconvenience caused by the device driver being stored in an optical disk or a magnetic disk is solved. The personal disk itself is a storage module, and a manual of the application module or software applications of the application module can be stored in the personal disk. Therefore, consumption of optical disks, magnetic disks, and paper is reduced. At the same time, the cost is accordingly lowered. The claimed peripheral device has a hub controller so that both the personal disk and the application module share the same port. Therefore, the computer host is capable of having more ports available to other external devices. In addition, the claimed peripheral device also has switches used for control power supply of the personal disk and the application module according to users demands so that the power consumption associated with the claimed peripheral device is greatly reduced.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of a prior art computer system.

FIG. 2 is a perspective diagram of a peripheral device according to the present invention.

FIG. 3 is a block diagram of the peripheral device according to the present invention.

FIG. 4 is a flow chart illustrating operation of the peripheral device shown in FIG. 3.

### DETAILED DESCRIPTION

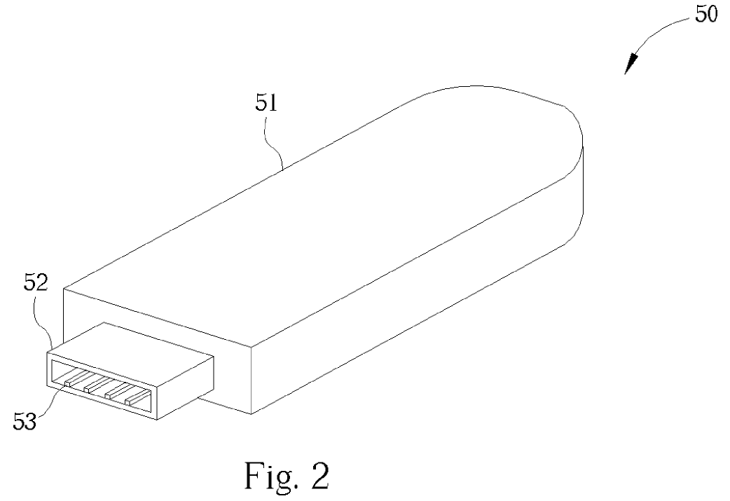

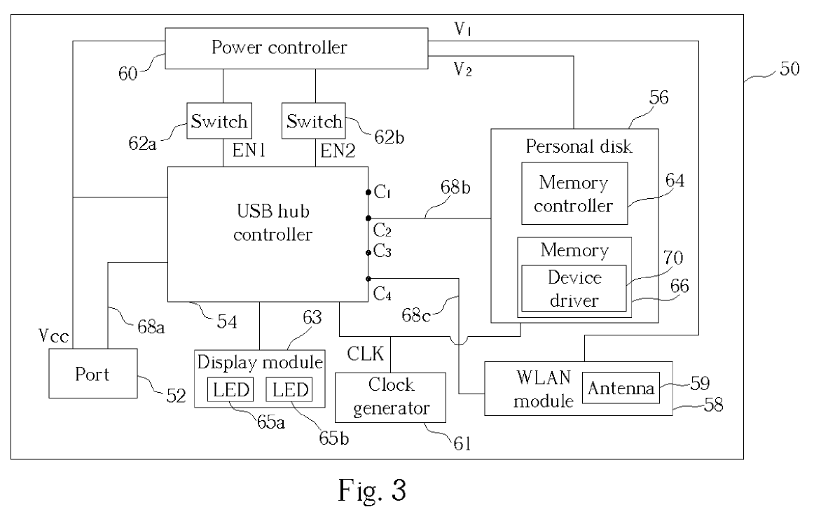

Please refer to FIG. 2 in conjunction with FIG. 3. FIG. 2 is a perspective diagram of the peripheral device 50 according to the present invention, and FIG. 3 is a block diagram of the peripheral device 50 according to the present invention. The peripheral device 50 has a housing 51 and a port 52. The housing 51 is used to protect internal components of the peripheral device 50. The port 52 is used to connect an interface port of an electronic device such as a computer host so as to install the peripheral device 50 on the electronic device. With regard to the peripheral device 50, the port 52 is a male connector, and the port 52 has a plurality of pins 53. Therefore, the interface port is required to be a female connector for connecting the port 52 successfully. As shown in FIG. 3, the peripheral device 50 includes the port 52, a USB hub controller 54, a personal disk 56, a WLAN module 58, a power controller 60, a clock generator 61, switches 62a, 62b, and a display module 63. The personal disk 56 has a memory controller 64 and a memory 66. In the preferred embodiment, hardware components such the USB hub controller 54, the personal disk 56, the WLAN module 58, the power controller 60, and switches 62a, 62b are positioned inside the housing 51 except the port 52. That is, the housing 51 is capable of protecting these above-mentioned internal hardware components from being damaged by external shock.

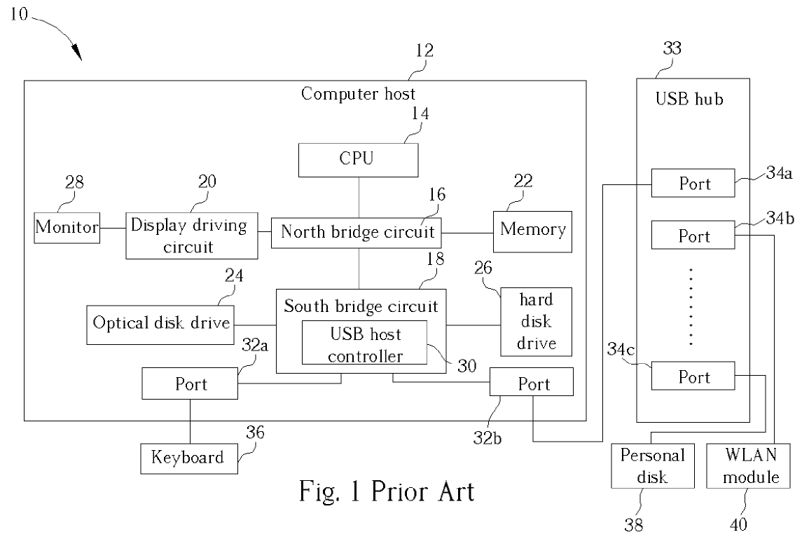

Suppose that the peripheral device 50 is capable of being installed on the computer host 12 shown in FIG. 1. As shown in FIG. 1, the computer host 12 has ports 32a, 32b. Therefore, the port 52 is capable of being connected to either the port 32a or the port 32b so as to install the peripheral device 50 on the computer host 12. For example, the ports 32a, 32b are USB female connectors, and the port 52 is a corresponding USB male connector. Therefore, the port 52 can be directly connected to either the port 32a or the port 32b. In addition, the port 52 also can be connected to either the port 32a or the port 32b through a well-known USB extended cable. The port 52 in the preferred embodiment functions as an upstream port, and is connected to the USB hub controller 54 through a data channel 68a. Besides, when the port 52 is connected to the port 32b of the computer host 32, it is well-known that the computer host 12 outputs an operating voltage Vcc from the port 32b to the corresponding port 52. Then, the received operating voltage Vcc is further passed to the USB hub controller 54 and the power controller 60. The USB hub controller 54 itself supports a plurality of downstream ports. In the preferred embodiment, the USB hub controller 54 supports only 4 input/output ports (I/O ports) C1, C2, C3, C4, wherein the I/O port C2 is connected to the personal disk 56 through a data channel 68b, and the I/O port C4 is connected to the WLAN module 58 through a data channel 68c. The USB hub controller 54, however, is capable of coordinating the personal disk 56 and the WLAN module 58 to share the common data channel 68a for delivering and receiving data. In addition, the memory controller 64 is used to control data access of the memory 66, and the memory 66 is a non-volatile memory such as a flash memory. Furthermore, the memory 66 records a device driver 70 of the WLAN driver 58.

In the preferred embodiment, an application module of the peripheral device 50 is capable of being at least partially positioned inside the housing 51. Taking the WLAN module 58 for example, it is partially positioned inside the housing 51 owing to an antenna 59 protruding from the housing 51 for transmitting and receiving radio frequency (RF) signals. However, a main body of the WLAN module 58 is still protected by the housing 51. The WLAN module 58 is used to access a computer network via wireless transmission. For example, a plurality of computer devices that have the WLAN modules 58 can access one wireless network via an access point. The switch 62a is used to determine if an enabling signal EN1 outputted from the USB hub controller 54 is delivered to the power controller 60. If the power controller 60 receives the enabling signal EN1, the power controller 60 outputs one driving voltage V to the WLAN module 58 so that the WLAN module 58 can function normally. In the preferred embodiment, the driving voltage V₁ is equal to the operating voltage Vcc. In addition, the switch 62b is used to determine if an enabling signal EN2 outputted from the USB hub controller 54 is delivered to the power controller 60. If the power controller 60 receives the enabling signal EN2, the power controller 60 outputs another driving voltage V₂ to the personal disk 56 so that the personal disk 56 can function normally. In the preferred embodiment, the driving voltage V₂ is equal to the operating voltage Vcc as well. According to users demands, the switches 62a, 62b are capable of being controlled to determine whether the WLAN module 58 and the personal disk 56 are powered to perform their functionality. To sum up, the personal disk 56 and the WLAN module 58 are respectively connected to the USB hub controller 54 through a predetermined inter-face. Therefore, the USB hub controller 54 is capable of controlling data transmission and driving voltages of the personal disk 56 and the WLAN module 58.

The clock generator 61 in the preferred embodiment is used for outputting a driving clock CLK. For instance, the clock generator 61 is a crystal oscillator used to generate the driving clock CLK with a predetermined frequency. If the peripheral device 50 conforms to the USB 1.1 specification, the maximum data transfer rate is 12 Mbps. Therefore, the clock generator 61 can be implemented by a crystal oscillator that is capable of outputting the driving clock CLK having a frequency equaling 12M. Because the USB hub controller 54 is edge-triggered by the driving clock CLK, the USB hub controller 54 is triggered by rising edges of the driving clock CLK for example, the maximum data transfer rate associated with the USB hub controller 54 is equal to 12 Mbps to meet the requirement defined by the USB 1.1 specification. Furthermore, the clock generator 61 shown in FIG. 3 is simultaneously connected to the USB hub controller 54 and the personal disk 56. The same driving clock CLK, therefore, drives both of the USB hub controller 54 and the personal disk 56. That is, the claimed peripheral device 50 only having one clock generator 61 is capable of achieving the goal of driving the USB hub controller 54 and the personal disk 56. In other words, the claimed peripheral device 50 can reduce its chip size and its production cost with the clock generator 61 jointly utilized by the USB hub controller 54 and the personal disk 56.

In the preferred embodiment, the display module 63 has two light emitting diodes (LEDs) 65a, 65b used for informing the user of current operating statuses associated with the personal disk 56 and the WLAN module 58. For instance, when the personal disk 56 and the USB hub controller 54 are successfully connected, the LED 65a is enabled. Similarly, when the WLAN module 58 and the USB hub controller 54 are successfully connected, the LED 65b is enabled as well. Therefore, the user can acknowledge whether the personal disk 56 and the WLAN module 58 function correctly through watching the LEDs 65a, 65b.

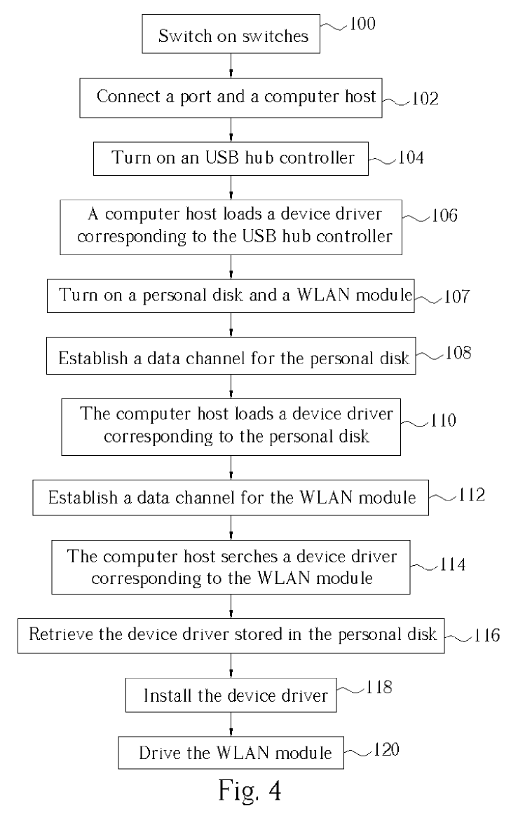

Please refer to FIG. 4 in conjunction with FIGS. 1 and 3. FIG. 4 is a flow chart illustrating operation of the peripheral device 50 shown in FIG. 3. The operation of the peripheral device 50 is described as follows. The peripheral device 50 can be installed on the computer host 12 such as a desktop computer, a notebook computer, or a personal digital assistant to expand functionality of the original computer host 12. If the peripheral device 50 is a new hardware component for the computer host 12, that is, the peripheral device 50 has never been installed on the computer host 12 before, the user needs to switch on the switches 62a, 62b so that the enabling signals EN1, EN2 are successfully transferred to the power controller 60 (step 100). Then, the port 52 is connected to the computer host 12. It is well-known that the ports 32a, 32b of the computer host 12 are female connectors, but the port 52 is a male connector that can be directly inserted into either the port 32a or the port 32b. Otherwise, the port 52 of the peripheral device 50 can be connected to one of the ports 32a, 32b through a USB extended cable (step 102). After the peripheral device 50 is electrically connected to the computer host 12, the USB host controller 30 outputs the operating voltage Vcc (5V) to the USB hub controller 54 and the power controller 60 in the peripheral device 50. Concerning the USB hub controller 54, the USB hub controller 54 starts working after receiving the operating voltage Vcc (step 104).

With regard to the power controller 60, the power controller 60 does not output the driving voltages V₁, V₂ that equal the operating voltage Vcc because the USB hub controller 54 does not trigger the enabling signals EN1, EN2 yet. After the USB hub controller 54 is turned on, the data channel 68a is established between the USB hub controller 54 and the USB host controller 30 for transmitting data. For instance, the USB hub controller 54 delivers hardware parameters to the USB host controller 30 so that the OS run on the computer host 12 is capable of detecting the added USB hub controller 54. Generally speaking, current operating systems such as Win 2000® and WinXP® already include the device driver of the USB hub controller 54. Therefore, the device driver of the USB hub controller 54 is successfully loaded to control the operation of the USB hub controller 54 (step 106). Because the operating voltage Vcc has been inputted into the USB hub controller 54 to activate the USB hub controller 54, the USB hub controller 54 starts triggering the enabling signal EN1, EN2 to drive the power controller 60 for outputting the driving voltages V₁, V₂ to the personal disk 56 and the WLAN module 58 (step 107). Please note that the data channel 68b between the personal disk 56 and the USB hub controller 54 and the data channel 68c between the WLAN module 58 and the USB hub controller 54 are not established yet though the driving voltages V₁, V₂ have been inputted into the personal disk 56 and the WLAN module 58. In other words, the USB hub controller 54 now does not enable the I/O port C2 corresponding to the personal disk 56 and the I/O port C3 corresponding to the WLAN module 58.

In the preferred embodiment, the USB hub controller 54 supports 4 downstream ports respectively corresponding to the I/O ports C1, C2, C3, C4. It is well-known that the USB hub controller 54 sequentially enables downstream ports. In other words, the USB hub controller 54 first enables the I/O port C1 for establishing a corresponding data channel between the I/O port C1 and a device connected to the I/O port C1. Then, the USB hub controller 54 enables the I/O port C2 for establishing a corresponding data channel between the I/O port C2 and a device connected to the I/O port C2. According to the I/O port sequence, the USB hub controller 54 finally enables the last I/O port C4 for establishing a corresponding data channel between the I/O port C4 and a device connected to the I/O port C4. The personal disk 56 is connected to the I/O port C2, and the WLAN module 58 is connected to the I/O port C4. Therefore, the USB hub controller 54 first enables the I/O port C2 to establish the data channel 68b between the USB hub controller 54 and the personal disk 56 (step 108). Now, the OS run by the computer host 12 detects the personal disk 56. Because the currently popularized operating systems such as Win 2000® and WinXP® support the personal disk 56, the embedded device driver for the personal disk 56 is successfully loaded to control the operation of the personal disk 56 (step 110). Because the WLAN module 58 is connected to the I/O port C4, the USB hub controller 54 enables the I/O port C4 for establishing the data channel 68c between the WLAN module 58 and the USB hub controller 54 after the data channel 68b has been established (step 112).

Now, the OS run by the computer host 12 detects the WLAN module 58. However, the OS does not support the specific WLAN module 58. Therefore, the OS is unable to find out a device driver suitable for the WLAN module 58 from the device drivers embedded in the OS. Generally speaking, the OS displays a dialog window to ask the user to provided the required device driver (step 114). Please note that the OS has executed the device driver of the personal disk 56 to control the operation of the personal disk 56 successfully. Therefore, a disk drive number is assigned to the personal disk 56. That is, the personal disk 56 accessed through the OS is like the hard disk drive 26 or the optical disk drive 24. In addition, the personal disk keeps the device driver 70 of the WLAN driver 58. Therefore, the user can direct the OS to retrieve the wanted device driver 70 from the personal disk 56. For example, suppose that the personal disk 56 corresponds to a disk drive number H in the OS. When the OS displays a dialog window to ask the user to manually provide the required device driver, the user locates the disk drive number H through operating the dialog window, and inputs the file name of the device driver 70 to inform the OS of the location associated with the device driver 70. Then, the OS starts installing the device driver 70 (step 118), and one copy of the device driver 70 is recorded on the hard disk drive 26. At the same time, hardware information of the WLAN module 58 and software information of the device driver 70 is recorded in a registry file. After the OS successfully loads the device driver 70, the computer host 12 is capable of driving the WLAN module 58 to perform a predetermined operation (step 120).

Because the personal disk 56 is used to store the device driver 70 of the WLAN module 58, the I/O port corresponding to the personal disk 56 has to be enabled before the I/O port corresponding to the WLAN module 58 for making use of the personal disk 56 to successfully install the device driver 70. In other words, if the personal disk 56 is connected to the I/O port C1, the WLAN module 58 can be connected to the I/O port C2, the I/O port C3, or the I/O port C4. The same goal of installing the device driver 70 through the personal disk 56 is achieved. The personal disk 56 itself is a memory device. Therefore, not only is the device driver 70 recorded, but also any kinds of data can be stored by the personal disk 70. For instance, the computer host 12 correctly drives the personal disk 56 and the WLAN module 58 in the peripheral device 50 after the above-mentioned steps are completed. If the user runs an application on the computer host 12 for retrieving a document file shared on a computer network, the computer host 12 can control the WLAN module 58 to retrieve the wanted document file. Then, the user opens this document file to edit it, and saves the edited document file to the memory 66 of the personal disk 56. The computer host 12 stores the document file no more after the peripheral device 50 is disconnected from the computer host 12 through a hot swap manner.

As mentioned above, the OS run by the computer host 12 can support the WLAN module 58 successfully after all of the steps shown in FIG. 4 are completed. In other words, the OS is capable of loading a corresponding device driver from the hard disk drive 26 according to related registry codes recorded in the registry file. If the user connects the peripheral device 50 and the computer host 12 later through the well-known hot swap manner, and the user only wants to utilize the WLAN module 58 to expand functionality of the computer host 12, the user switches the switch 62a on to pass the enabling signal EN1 to the power controller 60, and switches the switch 62b off to block the enabling signal EN2 from being delivered to the power controller 60. When the port 52 of the peripheral device 50 is electrically connected to either the port 32a or the port 32b, the power controller 60 does not output the driving voltage V₂ to the personal disk 56 because the enabling signal EN2 is not inputted into the power controller 60. That is, the personal disk 56 does not work successfully, and does not consume any power. Therefore, the overall power consumption of the peripheral device 50 is then reduced. In the preferred embodiment, the computer host 12 supplies the operating voltage Vcc for the peripheral device 50. If the computer host 12 is a portable device such as a notebook computer or a personal digital assistant, voltages levels are mainly driven by a battery device. With the reduction of the power consumption of the peripheral device 50, the operating time of the computer host 12 available to the user is accordingly increased.

Similarly, if the user connects the peripheral device 50 and the computer host 12 later through the well-known hot swap manner, and the user only wants to utilize the personal disk 56 to expand functionality of the computer host 12, the user switches the switch 62a off to block the enabling signal EN1 from being delivered to the power controller 60, and switches the switch 62b on to pass the enabling signal EN2 to the power controller 60. When the port 52 of the peripheral device 50 is electrically connected to either the port 32a or the port 32b, the power controller 60 does not output the driving voltage V1 to the WLAN module 58 because the enabling signal EN1 is not inputted into the power controller 60. Therefore, the WLAN module 58 is unable to work successfully, and does not consume any power. In other words, the overall power consumption of the peripheral device 50 is then reduced.

The peripheral device 50 has switches 62a, 62b set by the user to control whether the personal disk 56 and the WLAN module 58 are workable. In other words, when the switch 62a is turned on, and the switch 62b stays off, the peripheral device 50 functions as a stand-alone WLAN module 58. Similarly, when the switch 62b is turned on, and the switch 62a stays off, the peripheral device 50 functions as a stand-alone personal disk 56. However, when both switches 62a, 62b are switched on, the peripheral device 50 functions as a multi-functional device that supports data storage and wireless network access. In addition, the peripheral device 50 contains one USB hub controller 54. Therefore, the personal disk 56 and the WLAN module 58 shares the same data channel 68a with the help of the USB hub controller 54, and only one port 52 is required to connect one of the ports 32a, 32b on the computer host 12. The peripheral device 50 is capable of expanding functionality of the computer host 12 with the personal disk 56 and the WLAN module 58. However, only one port on the computer host 12 is occupied by the inserted peripheral device 50. Therefore, the claimed peripheral device 50 also makes more ports of the computer host 12 available to other external devices.

The circuit structure of the preferred embodiment is applied to a USB bus. However, the circuit structure of the preferred embodiment can be applied to other buses used by peripheral devices. Taking the IEEE1394 bus for example, the port 52 can be replaced by an IEEE1394-compatible male connector, and the USB hub controller 54 can be replaced by an IEEE1394 hub controller. Then, the amended circuit structure is capable of transmitting and receiving data via the IEEE1394 bus. In addition, the personal disk 56 is used to provide the WLAN module 58 with an appropriate device driver. However, the personal disk 56 can be applied to provide other peripheral devices with appropriate device drivers. For example, the personal disk 56 is installed on a printer, and the device driver 70 stored by the memory 66 is a device driver for the printer. As mentioned above, currently popularized operating systems such as Win 2000® and WinXP® support the personal disk 56, and have an embedded software driver for the personal disk 56. Therefore, data stored in the personal disk 56 can be retrieved successfully. Similarly, when the OS detects that the connected printer is a new hardware component, the OS reads and loads the device driver 70 corresponding to the printer from the personal disk 56. Then, the OS is capable of controlling the operation of the added printer.

The personal disk 56 mentioned above is viewed as a storage device for storing any formats of data such as installation files of device drivers, installation files of applications, and document files. When the personal disk 56 is combined with an application module such as the WLAN module 58 shown in FIG. 3 and the above-mentioned printer, and the personal disk 56 and the application module are positioned inside the peripheral device 50, the personal disk 56 can be used to store any data generated during the operation of the application module. For example, suppose that the application module is a GPS module used for receiving a plurality of orientation signals and converting the orientation signals into a corresponding coordinate value. The personal disk 56 not only stores a software drive of the GPS module, but also is used to store a map file, an e-MAP navigatorapplication, and manuals of the GPS module and the e-MAP navigatorapplication. When the peripheral device 50 is installed on the computer host 12, the device driver recorded by the personal disk is retrieved by the computer host 12 to drive the newly added GPS module. Then, the computer host 12 utilizes the personal disk 56 to install the e-MAP navigatorapplication. In the end, the computer host 12 runs the e-MAP navigatorapplication to display a current location of the computer host 12 on the monitor 28 shown in FIG. 1 through the coordinate value provided by the GPS module and the map file provided by the personal disk 56. To sum up, the personal disk 56 does not merely store device drivers. With regard to the application modules inside the peripheral device 50, the personal disk 56 is capable of recording device drivers, software applications, and manuals corresponding to the application modules. Therefore, a total amount of used optical disks, used magnetic disks, and used paper are greatly reduced.

In contrast to the prior art, the claimed peripheral device combines a personal disk and an application module. Therefore, when the user carries the claimed peripheral device, a device driver of the application module travels along with the application module. When the claimed peripheral device is connected to a computer host, the computer host is capable of retrieving and loading the device driver recorded by the personal disk to correctly drive the added application module to perform a predetermined operation. Therefore, the inconvenience caused by the device driver being stored in an optical disk or a magnetic disk is solved. In addition, the personal disk itself is a storage device, and a manual of the application module or software applications of the application module can be stored in the personal disk. Therefore, consumption of optical disks, magnetic disks, and paper is reduced. At the same time, the cost is accordingly lowered. Furthermore, the claimed peripheral device has a hub controller so that both the personal disk and the application module share the same port. Therefore, the computer host is capable of having more ports available to other external devices. The claimed peripheral device also has switches used for control power supply of the personal disk and the application module according to users demands so that the power consumption associated with the claimed peripheral device is greatly reduced.

1. A peripheral device capable of being connected to an interface port on an electronic device host, the peripheral device comprising:
a housing;
an application module positioned at least partially inside the housing;
a storage module positioned inside the housing for storing a device driver of the application module; and
a hub controller positioned inside the housing, the hub controller being electrically connected to the application module and the storage module;
wherein when the hub controller is electrically connected to the interface port, the electronic device host is capable of retrieving the device driver stored by the storage module and running the device driver to operate the application module.

2. The peripheral device of claim 1 wherein the interface port is a universal serial bus (USB) port, and the hub controller is a USB hub controller.

3. The peripheral device of claim 1 wherein the storage module is a personal disk, and the personal disk comprises a non-volatile memory for storing the device driver.

4. The peripheral device of claim 3 wherein the nonvolatile memory is a flash memory.

5. The peripheral device of claim 1 wherein the application module is a WLAN module for accessing a network through wireless transmission.

6. The peripheral device of claim 1 further comprising a power controller electrically connected to the storage module and the application module for controlling if a predetermined voltage is delivered to the storage module to enable the storage module and controlling if the predetermined voltage is delivered to the application module to enable the application module.

7. The peripheral device of claim 6 wherein the predetermined mined voltage is outputted from the electronic device host through the interface port.

8. The peripheral device of claim 1 wherein the storage module is electrically connected to a first port of the hub controller, the application module is electrically connected to a second port of the hub controller, and the hub controller enables the first port before enabling the second port.

9. The peripheral device of claim 1 wherein the interface port is an IEEE1394 port, and the hub controller is an IEEE1394 hub controller.

10. A method of driving a peripheral device, the peripheral device capable of being connected to an interface port on an electronic device host, the peripheral device comprising an application module, a storage module, and a hub controller, the method comprising:
connecting the peripheral device and the interface port;
enabling the hub controller for controlling data transmission among the application module, the storage module, and the electronic device host;
enabling the storage module;
utilizing the electronic device host for retrieving a device driver of the application module from the storage module through the hub controller; and
running the device driver to operate the application module.

11. The method of claim 10 further comprising:
controlling if a predetermined voltage is delivered to the storage module to enable the storage module; and
controlling if the predetermined voltage is delivered to the application module to enable the application module.

12. The method of claim 11 wherein the predetermined voltage is outputted from the electronic device host through the interface port.

13. The method of claim 10 wherein the interface port is an IEEE1394 port, and the hub controller is an IEEE1394 hub controller.

14. The method of claim 10 wherein the interface port is a universal serial bus (USB) port, and the hub controller is a USB hub controller.

15. The method of claim 10 wherein the storage module is a personal disk, and the personal disk comprises a non-volatile memory for storing the device driver.

16. The method of claim 15 wherein the non-volatile memory is a flash memory.

17. The method of claim 10 wherein the application module is a WLAN module for accessing a network through wireless transmission.

18. The method of claim 10 wherein the storage module is enabled before enabling the application module.

19. A peripheral device capable of being connected to an interface port of a host, the peripheral device comprising:
a connector having a plurality of pins for connecting the interface port of the host;
a hub controller electrically connected to the connector;
an application module electrically connected to the hub controller; and
a storage module electrically connected to the hub controller for storing data.

20. The peripheral device of claim 19 wherein the application module is a WLAN module, and the WLAN module comprises an antenna.

21. The peripheral device of claim 19 further comprising an application interface and a storage interface, wherein the application module is electrically connected to the hub controller through the application interface, and the storage module is electrically connected to the hub controller through the storage interface.

22. The peripheral device of claim 21 wherein the application module is a WLAN module, and the WLAN module comprises an antenna.

23. The peripheral device of claim 21 wherein the application interface comprises a switch for controlling whether the application module is enabled.

24. The peripheral device of claim 23 wherein the application module is a WLAN module, and the WLAN module comprises an antenna.

25. The peripheral device of claim 20, wherein the interface port corresponds to a serial bus, and the hub controller comprises a first port electrically connected to the storage module and a second port electrically connected to the application module.

26. A peripheral device capable of being connected to an interface port of a host, the peripheral device comprising:
a connector having a plurality of pins for connecting the interface port of the host;
a hub controller electrically connected to the connector; and
a storage module electrically connected to the hub controller for storing data;
wherein the storage module stores a device driver of the peripheral device in advance, and the host retrieves the device driver from the storage module when the peripheral device is connected to the interface port for a first time.

27. The peripheral device of claim 26 further comprising an application module electrically connected to the hub controller for performing a predetermined operation.

28. The peripheral device of claim 27 wherein the application module is a WLAN module, and the WLAN module comprises an antenna.

29. The peripheral device of claim 27 further comprising an application interface and a storage interface, wherein the application module is electrically connected to the hub controller through the application interface, and the storage module is electrically connected to the hub controller through the storage interface.

30. The peripheral device of claim 29 wherein the application cation module is a WLAN module, and the WLAN module comprises an antenna.

31. The peripheral device of claim 29 wherein the application interface comprises a switch for controlling if the application module is enabled.

32. The peripheral device of claim 31 wherein the application module is a WLAN module, and the WLAN module comprises an antenna.

33. The peripheral device of claim 27, wherein the interface port corresponds to a serial bus, and the hub controller comprises a first port electrically connected to the storage module and a second port electrically connected to the application module.

34. The peripheral device of claim 33 wherein when the peripheral device is connected to the interface port of the host, the host is first electrically connected to the storage module through the first port of the hub controller, and then the host is electrically connected to the application module through the second port of the hub controller.

35. A data access system comprising:
an electronic device host; and
a peripheral device capable of being connected to an interface port of the electronic device host, the peripheral device comprising:
a housing;
an application module for accessing data;
a storage module positioned inside the housing; and
a hub controller positioned inside the housing, the hub controller being electrically connected to the application module and the storage module;
wherein when the hub controller is electrically connected to the interface port, the electronic device host is capable of retrieving the data through the hub controller, and
the electronic device host is capable of transferring the data to the storage module through the hub controller for storing the data in the storage module.

36. The data access system of claim 35 wherein the application module is a WLAN module, and the storage module is a personal disk.
